(19) United States
(12) Patent Application Publication
(10) Pub. No.: US 2013/0272138 A1
(43) Pub. Date: Oct. 17, 2013

(54) METHOD AND APPARATUS FOR MONITORING A PDCCH (PHYSICAL DOWNLINK CHANNEL) IN A WIRELESS COMMUNICATION NETWORK

(71) Applicant: INNOVATIVE SONIC CORPORATION, Taipei City (TW)

(72) Inventor: Meng-Hui Ou, Taipei City (TW)

(21) Appl. No.: 13/845,551

(22) Filed: Mar. 18, 2013

Related U.S. Application Data
(60) Provisional application No. 61/612,692, filed on Mar. 19, 2012.

(51) Int. Cl. H04W 24/02

(52) U.S. Cl. CPC H04W 24/02
USPC 370/241

(57) ABSTRACT

A method and apparatus are disclosed for a monitoring PDCCH (Physical Downlink Control Channel). The method includes being configured with DRX (Discontinuous Reception) at a UE (User Equipment). The method also includes performing, at the UE, a measurement on a serving cell or PCell (Primary Cell). The method further includes monitoring, at the UE, the PDCCH more frequently after detecting that the quality of the serving cell or PCell is not good or is lower than a predetermined threshold.

### CROSS-REFERENCE TO RELATED APPLICATIONS

The present Application claims the benefit of U.S. Provisional Patent Application Ser. No. 61/612,692 filed on Mar. 19, 2012, the entire disclosure of which is incorporated herein by reference.

### FIELD

This disclosure generally relates to wireless communication networks, and more particularly, to a method and apparatus for monitoring a PDCCH (Physical Downlink Channel) in a wireless communication network.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed for monitoring a PDCCH (Physical Downlink Control Channel). The method includes being configured with DRX (Discontinuous Reception) at a UE (User Equipment). The method also includes performing, at the UE, a measurement on a serving cell or PCell (Primary Cell). The method further includes monitoring, at the UE, the PDCCH more frequently after detecting that the quality of the serving cell is not good or is lower than a threshold.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a timing diagram according to one exemplary embodiment.

FIG. 6 is a timing diagram according to one exemplary embodiment.

FIG. 7 is a reproduction of FIG. 5.4.3-1 of RAN2#77 Draft Meeting Notes.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. RP-120256, 3GPP Work Item Description “LTE RAN Enhancements for Diverse Data Applications”; RAN2 E-mail discussion [77#27] LTE: EDDA: TP for TR on power consumption and DRX; TR 36.822 V0.3.0, “LTE RAN Enhancements for Diverse Data Applications (Release 11)”; RAN2#77 Draft Meeting Notes (see http://www.3gpp.org/ftp/tsg_ran/WG2_RL2/TSGR2_{—}77/Report/); TS 36.321 V10.4.0, “E-UTRA; MAC protocol specification (Release 10)”; TS 36.133 V10.5.0, “Requirements for support of radio resource management (Release 10)”; and TS 36.331 V10.4.0, “E-UTRA; RRC protocol specification (Release 10)”. The standards and documents listed above are hereby expressly incorporated herein.

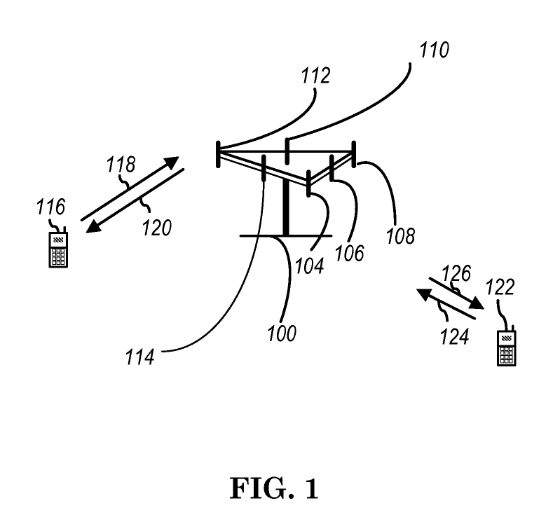

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

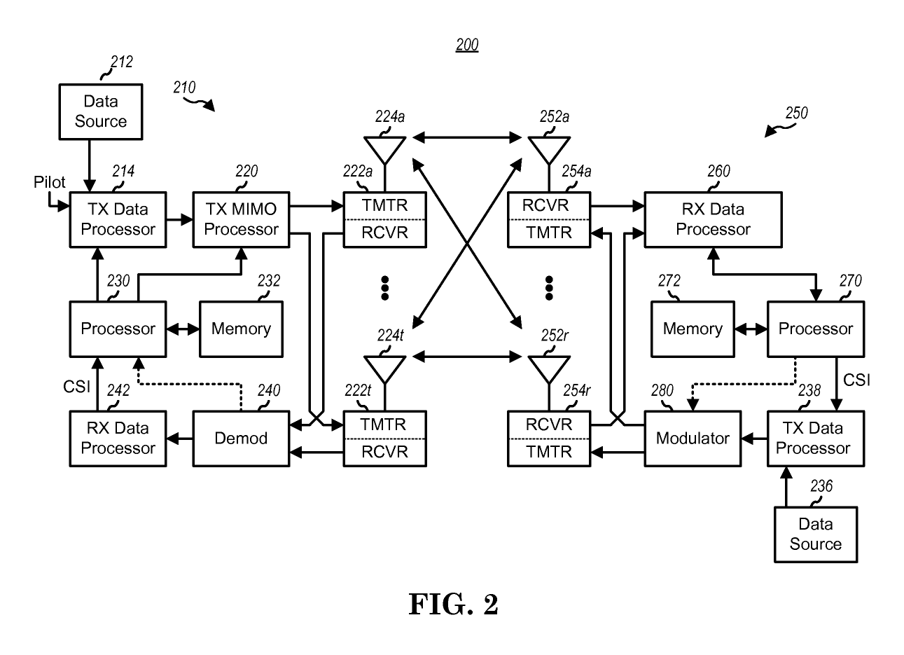

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

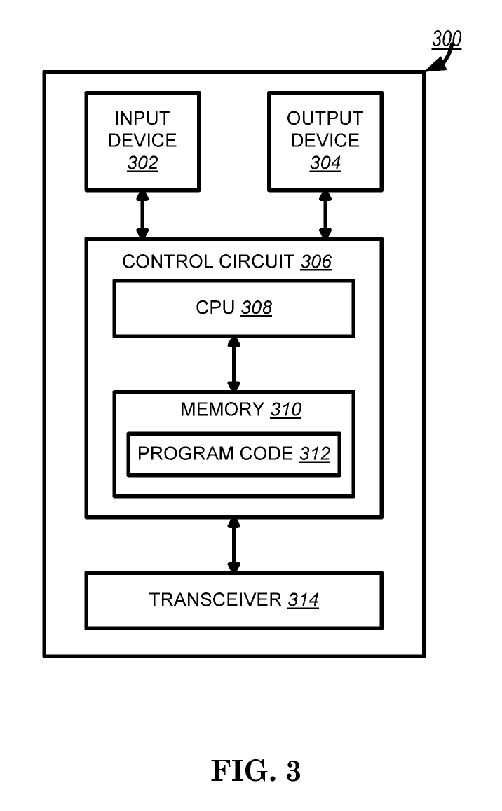

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

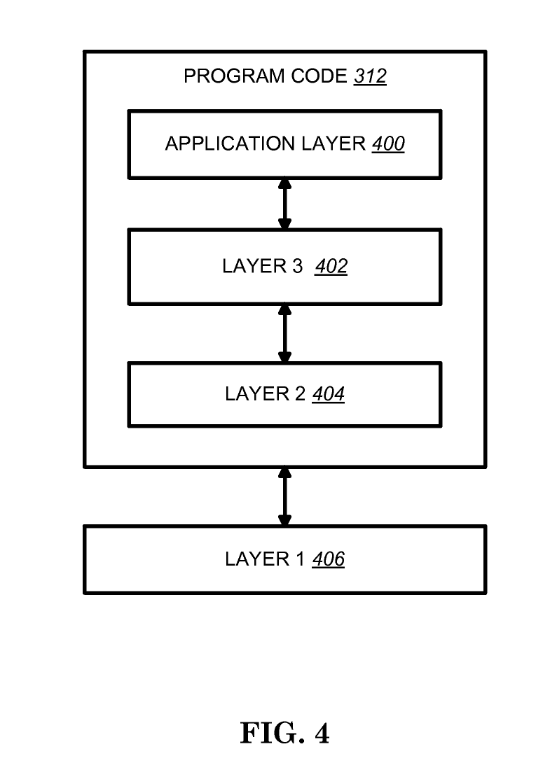

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

The WI (Work Item): Enhancements for Diverse Data Applications (EDDA) has been agreed to be studied in LTE Rel-11. According to 3GPP RP-120256, one of the objectives of the EDDA is to improve performance and power consumption through DRX operation enhancement as follows:
Enhancements to DRX configuration/control mechanisms to be more responsive to the needs and activity of either single or multiple applications running in parallel, with improved adaptability to time-varying traffic profiles and to application requirements, thereby allowing for an improved optimisation of the trade-off between performance and UE-battery-consumption.

Currently, a discussion (i.e., 3GPP RAN2 E-mail discussion [77#27] LTE: EDDA: TP for TR on power consumption and DRX) about EDDA is currently ongoing. The intention of this discussion is to prepare a text proposal of 3GPP TR 36.822 to capture simulation results on power consumption with DRX (Discontinuous Reception) based on contributions provided to RAN2 #77 meeting. Contributions of RAN2 #77 meeting are shown in RAN2#77 Draft Meeting Notes (available at http://www.3.gpp.org/ftp/tsg_ran/WG2_RL2/TSGR2_{—}77/Report/). In the discussion, the impact of different DRX cycle lengths and UE velocities on handover performance was studied and described as follows:

5.4.3 Trade-Off between Power Consumption and Handover Performance
The use of longer DRX cycles has some potential to impact handover performance and this is evaluated in this section. This impact may be due to reduced frequency of L1 measurements or increased latency of signalling messages.
The results of FIG. [7] show the percentage of radio link failures per successful handover.

FIG. [7]: UE handover performance as a function of mobility and DRX cycle length Note: The above figures are taken from R2-120578. The following observations can be made from the above figure:
Rate of radio link failure increases with longer DRX cycles
For high mobility cases, it is preferable to keep the UE either in RRC idle state or in RRC connected state with a short DRX cycle length

In addition, the current DRX operation is specified in the MAC specification (3GPP TS 36.321 V10.4.0). According to TS 36.321 V10.4.0, a UE would determine when to monitor PDCCH based on the configured DRX operation as follows:

When a DRX cycle is configured, the Active Time includes the time while:
onDurationTimer or drx-InactivityTimer or drx-RetransmissionTimer or mac-ContentionResolutionTimer (as described in subclause 5.1.5) is running; or
a Scheduling Request is sent on PUCCH and is pending (as described in subclause 5.4.4); or
an uplink grant for a pending HARQ retransmission can occur and there is data in the corresponding HARQ buffer; or
a PDCCH indicating a new transmission addressed to the C-RNTI of the UE has not been received after successful reception of a Random Access Response for the preamble not selected by the UE (as described in subclause 5.1.4).
   When DRX is configured, the UE shall for each subframe:
if a HARQ RTT Timer expires in this subframe and the data of the corresponding HARQ process was not successfully decoded:
   start the drx-RetransmissionTimer for the corresponding HARQ process.
if a DRX Command MAC control element is received:
   stop onDurationTimer;
   stop drx-InactivityTimer.
if drx-InactivityTimer expires or a DRX Command MAC control element is received in this subframe:
   if the Short DRX cycle is configured:
      start or restart drxShortCycleTimer;
      use the Short DRX Cycle.
   else:
      use the Long DRX cycle.
if drxShortCycleTimer expires in this subframe:
   use the Long DRX cycle.
If the Short DRX Cycle is used and [(SFN*10)+subframe number] modulo (shortDRX-Cycle)=(drxStartOffset) modulo (shortDRX-Cycle); or
if the Long DRX Cycle is used and [(SFN*10)+subframe number] modulo (longDRX-Cycle)=drxStartOffset:
   start onDurationTimer.
during the Active Time, for a PDCCH-subframe, if the subframe is not required for uplink transmission for half-duplex FDD UE operation and if the subframe is not part of a configured measurement gap:
   monitor the PDCCH;
   if the PDCCH indicates a DL transmission or if a DL assignment has been configured for this subframe:
      start the HARQ RTT Timer for the corresponding HARQ process;
      stop the drx-Retransmission Timer for the corresponding HARQ process.
   if the PDCCH indicates a new transmission (DL or UL):
      start or restart drx-InactivityTimer.
when not in Active Time, type-0-triggered SRS [2] shall not be reported.
if CQI masking (cqi-Mask) is setup by upper layers:
   when onDurationTimer is not running, CQI/PMI/RI/PTI on PUCCH shall not be reported.
else:
   when not in Active Time, CQI/PMI/RI/PTI on PUCCH shall not be reported.

Furthermore, when different DRX cycle lengths are configured, the requirement of layer 1 measurements corresponding to different DRX cycle lengths are specified in 3GPP TS 36.133 V10.5.0.

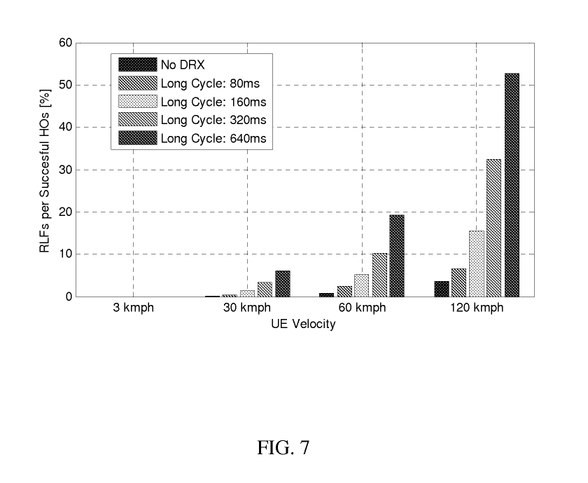

In general, it can be seen from FIG. 7 (extracted from Section 5.4.3 of the draft text proposal discussed in 3GPP RAN2 E-mail discussion [77#27] LTE: EDDA: TP for TR on power consumption and DRX) that when the UE's mobility is low, DRX would have less impact on RLF (Radio Link Failure) rate. But when the UE's mobility is high, long DRX may cause frequent RLF. As such, it would be preferable to keep the UE in the RRC (Radio Resource Control) idle state or connected state with a short DRX cycle length when the UE's mobility is high.

However, the UE configured with a shorter DRX cycle has worse performance on the power consumption. Currently, it seems that there is no efficient method for the network to detect the precise velocity of the UE. If the network could not estimate the UE's mobility accurately and promptly, it would be difficult to configure DRX cycle based on UE's mobility. In addition, if the high mobility UE is always configured with a shorter DRX cycle, power may be wasted unnecessarily. Under the circumstances, the UE's mobility should not the only factor to affect the used DRX cycle in order to improve the handover performance while still optimizing the power consumption.

The general concept of the invention is to enable a UE (especially the UE in high mobility) to monitor PDCCH more frequently when there is potential to handover so that the handover command can be received promptly. In one embodiment, when the current detected serving cell or PCell (Primary Cell) quality is not good (for example, lower than a threshold), the UE would monitor PDCCH more frequently than normal. In another embodiment, after a measurement report is transmitted, the UE would monitor PDCCH more frequently than normal. In this embodiment, the operation of a measurement report is specified in 3GPP TS 36.331 V10.4.0.

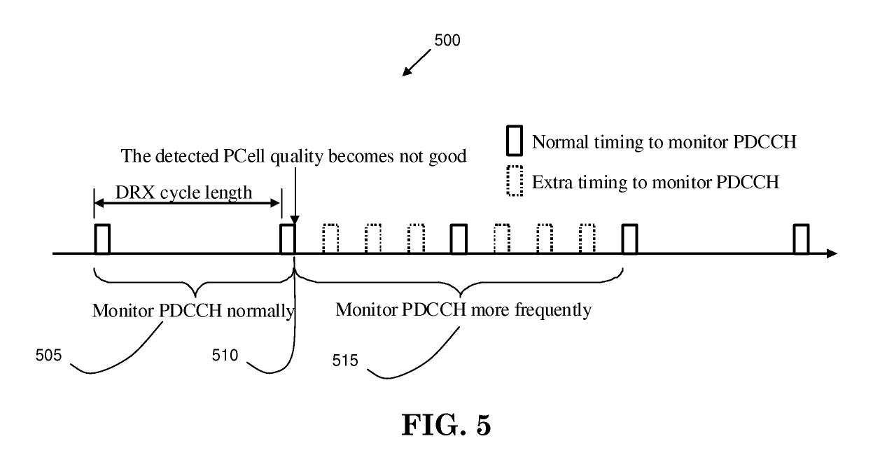

FIG. 5 is a timing diagram 500 according to one exemplary embodiment. During the time period 505, the UE would monitor the PDCCH normally. At time 510, the UE detects that the quality of the serving cell or PCell (Primary Cell) becomes not good (for example, dropping below a quality threshold). During the time period 515, the UE monitors the PDCCH more frequently. As shown in FIG. 5, during the timer period 515, extra occasions would be added to monitor the PDCCH.

Referring back to FIGS. 3 and 4, the device 300 includes a program code 312 stored in memory 310. In one embodiment, the CPU 308 could execute the program code 312 (i) to be configured with DRX (Discontinuous Reception) at a UE (User Equipment), (ii) to perform, at the UE, a measurement on a serving cell or PCell (Primary Cell), and (iii) to monitor, at the UE, the PDCCH more frequently after detecting that the quality of the serving cell or PCell is not good or is lower than a threshold.

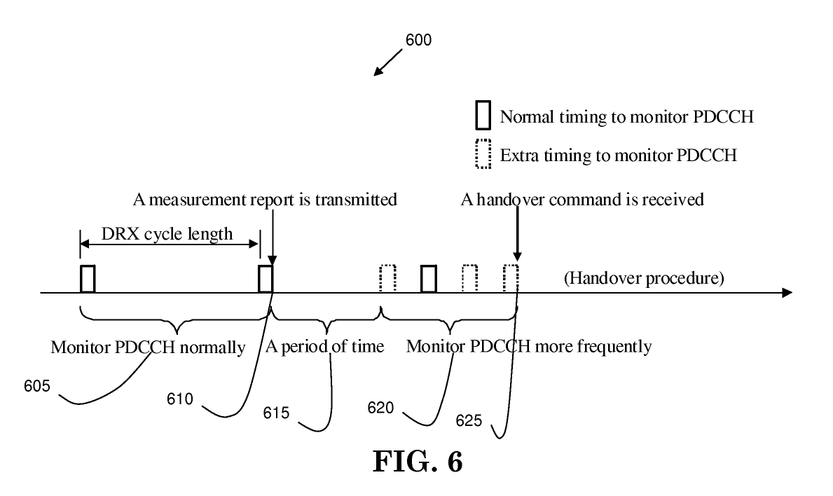

FIG. 6 is a timing diagram 600 according to one exemplary embodiment. During the time period 605, the UE would monitor the PDCCH normally. At time 610, the UE detects that the quality of the serving cell or PCell (Primary Cell) becomes not good (for example, dropping below a quality threshold); and the UE transmits a measurement report which may report or indicate that the quality of the serving cell or PCell has deteriorated. In one embodiment, the measurement report is triggered by event A2, A3, or A5. In another embodiment, the measurement report is transmitted successfully or is ACKed (Acknowledged) by a lower layer.

Returning to FIG. 6, in one embodiment, there may be a time period 615 between the time that a measurement report is transmitted and the time that the UE start to monitor PDCCH more frequently. In another embodiment, the UE monitors the PDCCH more frequently until a handover command is received. As shown in FIG. 6, during the time period 620, extra occasions would be added to monitor the PDCCH.

Referring back to FIGS. 3 and 4, the device 300 includes a program code 312 stored in memory 310. In one embodiment, the CPU 308 could execute the program code 312 (i) to be configured with DRX (Discontinuous Reception) at a UE (User Equipment), (ii) to perform, at the UE, a measurement on a serving cell or PCell (Primary Cell), and (iii) to monitor, at the UE, the PDCCH more frequently after a measurement report is transmitted. The measurement report may indicate that the quality of the serving cell or PCell is not good or is lower than a threshold.

In one embodiment, the UE would monitor the PDCCH while in Active Time when DRX is configured. In this embodiment, the UE would monitor the PDCCH more frequently by keeping itself in Active Time, by shortening a DRX cycle length, or by leaving the DRX mode. In another embodiment, the UE would monitor the PDCCH normally when the UE is not in a high mobility state or not moving fast. Furthermore, the UE would monitor the PDCCH more frequently for a period of time after detecting that the quality of the serving cell or PCell is lower than a threshold. In an alternative embodiment, the UE would monitor the PDCCH more frequently until a handover command is received. However, the UE would monitor the PDCCH normally after the period of time expires if no handover command is received. In one embodiment, the period of time could be several DRX cycles, or could be controlled by a timer. In another embodiment, the UE starts to monitor the PDCCH more frequently after a period of time that the quality of the serving cell or PCell becomes not good or a measurement report is transmitted. The intention is to enable network to prepare a handover.

In an alternative embodiment, the UE is running some specific type of traffic (such as background traffic). And if the UE is running a traffic other than the specific type of traffic (e.g., other than the background traffic), the UE would monitor the PDCCH normally based on the configured DRX.

In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for monitoring a PDCCH (Physical Downlink Control Channel), comprising:
being configured, at a UE (User Equipment), with DRX (Discontinuous Reception);
performing, at the UE, a measurement on a serving cell or PCell (Primary Cell); and
monitoring, at the UE, the PDCCH more frequently after detecting that the quality of the serving cell or PCell is not good or is lower than a threshold.

2. The method of claim 1, wherein the UE monitors the PDCCH while in Active Time when DRX is configured.

3. The method of claim 1, wherein the UE monitors the PDCCH more frequently by keeping itself in Active Time, by shortening a DRX cycle length, or by leaving the DRX mode.

4. The method of claim 1, wherein the UE monitors the PDCCH normally when the UE is not in a high mobility state or not moving fast.

5. The method of claim 1, wherein the UE monitors the PDCCH more frequently for a period of time after detecting that the quality of the serving cell or PCell is lower than a threshold.

6. The method of claim 1, wherein the UE monitors the PDCCCH more frequently until a handover command is received.

7. A communication device for monitoring a PDCCH (Physical Downlink Control Channel), comprising, the communication device comprising:
a control circuit;
a processor installed in the control circuit;
a memory installed in the control circuit and operatively coupled to the processor;
wherein the processor is configured to execute a program code stored in memory to monitor the PDCCH (Physical Downlink Control Channel) by:
being configured, at a UE (User Equipment), with DRX (Discontinuous Reception);
performing, at the UE, a measurement on a serving cell or PCeIl (Primary Cell); and
monitoring, at the UE, the PDCCH more frequently after detecting that the quality of the serving cell or PCell is not good or is lower than a threshold.

8. The communication device of claim 7, wherein the UE monitors the PDCCH while in Active Time when DRX is configured.

9. The communication device of claim 7, wherein the UE monitors the PDCCH more frequently by keeping itself in Active Time, by shortening a DRX cycle length, or by leaving the DRX mode.

10. The communication device of claim 7, wherein the UE monitors the PDCCH normally when the UE is not in a high mobility state or not moving fast.

11. The communication device of claim 7, wherein the UE monitors the PDCCH more frequently for a period, of time after detecting that the quality of the serving cell or PCell is lower than a threshold.

12. The communication device of claim 7, wherein the UE monitors the PDCCH more frequently until a handover command is received.

13. A method for monitoring a PDCCH (Physical Downlink Control Channel), comprising:
being configured, at a UE (User Equipment), with DRX (Discontinuous Reception);
performing, at the UE, a measurement on a serving cell or PCell (Primary Cell); and
monitoring, at the UE, the PDCCH more frequently after a measurement report is transmitted.

14. The method of claim 13, wherein the measurement report indicates that the quality of the serving cell or PCell is not good or is lower than a threshold.

15. The method of claim 13, wherein the measurement report is triggered by event A2, A3, or A5.

16. The method of claim 13, wherein the UE monitors the PDCCH while in Active Time when DRX is configured.

17. The method of claim 13, wherein the UE monitors the PDCCH more frequently by keeping itself in Active Time, by shortening a DM cycle length, or by leaving the DRX mode.

18. The method of claim 13, wherein the UE monitors the PDCCH normally when the UE is not in a high mobility state or not moving fast.

19. The method of claim 13, wherein the UE monitors the PDCCH more frequently for period of time after detecting that the quality of the serving cell or PCell is lower than a threshold.

20. The method of claim 13, wherein the UE monitors the PDCCH more frequently until a handover command is received.
